(19) United States
(12) Patent Application Publication
(10) Pub. No.: US 2026/0370646 A1
(43) Pub. Date: Nov. 19, 2026

(54) SECURE METHOD USING TOKEN AND IDENTITY DATA

(71) Applicant: Visa International Service Association, San Francisco, CA (US)

(72) Inventors: Elen Marie Austenaa, Oslo (NO); Ranjiva Kant Prasad, Hampshire (GB); Mathieu Andre Guy Altwegg, Pfaffikon (CH)

(73) Assignee: Visa International Service Association, San Francisco, CA (US)

(21) Appl. No.: 19/487,836

(22) PCT Filed: May 28, 2024
(86) PCT No.: PCT/US2024/031231

§ 371 Date: Nov. 25, 2025

Related U.S. Application Data
(60) Provisional application No. 63/505,332, filed on May 31, 2023.

(51) Int. Cl. H04L 9/40

(52) U.S. Cl. CPC H04L 63/10; H04L 63/083

(57) ABSTRACT

A method is disclosed. The method comprises receiving, by a token service computer from a token requestor, a request message comprising a first type of access data. The request message requests a second type of access data and a set of user attributes or assertions thereof for a user. The method further includes transmitting, to an identity hub, a request for the set of user attributes or assertions thereof of the user, the request including the first type of access data, and receiving, from the identity hub, a response message comprising the requested set of user attributes or assertions thereof of the user. The method further includes providing, to the token requestor, a modified response message including the requested set of user attributes or assertions thereof of the user and the second type of access data.

### CROSS-REFERENCES TO RELATED APPLICATIONS

This application is a PCT application which claims priority to U.S. Provisional Application No. 63/505,332, filed on May 31, 2023, which is herein incorporated by reference in its entirety.

### BACKGROUND

Transactions to access resources often rely on the use of credentials. In a conventional interaction, a user may provide a credential to a resource provider to gain access to resources such as secure data, goods, or secure locations. However, when the credential is stored and is passed through a computer network to the resource provider that will provide the resource, the credential is subject to man-in-the-middle attacks or hackers. Thus, a problem that needs to be addressed relates to improving the security of interactions involving credentials.

Another problem that exists with convention interactions is that a resource provider may need additional information about a user before the resource provider provides a requested resource to the user. This may require that the user retrieve an additional type of access data or a different type of credential. This is inconvenient for the user and also the resource provider, as it involves multiple steps. When multiple steps are required, additional computing resources are consumed.

As an illustration, a user may wish to access secure data on a secure server and may provide login information including a username and password. This may be insufficient for the secure server to grant the user access to the secure data. The secure server may desire other information of the user before doing so. For example, the user may be asked to provide a copy of a credential such as a copy of the user's driver's license before the user may access the secure data. This requires the user to either separately retrieve or obtain a digital copy of the driver's license and then provide it to the secure server. The user must perform this series of steps every time the resource provider requires it, and the number of interactions, messages, and computations increases significantly when a large number of users are performing such actions. In addition, the user's credentials are sensitive information and are also subject to man-in-the-middle attacks and hacking.

Another problem is that the users' data can be shared without the control of the user. For instance, the entity that receives the confirmation of a driving license from the user might share the data further with other unrelated parties or the data might be stolen and pose a security risk to the user.

Embodiments of the disclosure address this problem and other problems individually and collectively.

### BRIEF SUMMARY

One embodiment of the invention includes a method comprising: receiving, by a token service computer from a token requestor, a request message comprising a first type of access data, the request message requesting a second type of access data and a set of user attributes or assertions thereof for a user; transmitting, by the token service computer to an identity hub, a request for the set of user attributes or assertions thereof of the user, the request comprising the first type of access data; receiving, by the token service computer from the identity hub, a response message comprising the requested set of user attributes or assertions thereof of the user; and providing, by the token service computer to the token requestor, a modified response message comprising the requested set of user attributes or assertions thereof of the user and the second type of access data.

Another embodiment of the invention includes a token service computer comprising: a processor; and a computer readable medium comprising code executable by the processor for performing operations comprising: receiving, from a token requestor, a request message comprising a first type of access data, the request message requesting a second type of access data and a set of user attributes or assertions thereof for a user; transmitting, to an identity hub, a request for the set of user attributes or assertions thereof of the user, the request comprising the first type of access data; receiving, from the identity hub, a response message comprising the requested set of user attributes or assertions thereof of the user; and providing, to the token requestor, a modified response message requested set of user attributes or assertions thereof of the user and the second type of access data.

Another embodiment of the invention includes a method comprising: receiving, by an identity hub from a token service computer, a request for a set of user attributes or assertions thereof of a user, the request comprising a first type of access data; after receiving the request for the set of user attributes or assertions thereof of the user, obtaining, by the identity hub from an alias directory, an electronic identifier using the first type of access data; obtaining the requested set of user attributes or assertions thereof of the user from an identity provider computer using the electronic identifier; and transmitting, by the identity hub to the token service computer, a response message comprising the requested set of user attributes or assertions thereof of the user.

These and other embodiments are described in further detail below.

### TERMS

Before discussing specific embodiments of the invention, some descriptions of some terms may be helpful.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “value interaction” may be an interaction where value is transferred from one entity to another. Examples of value interactions may include payment and settlement interactions. Value may include currency, goods, cryptocurrency, etc.

A “user” may include an individual. In some embodiments, a user may be associated with one or more personal accounts and/or user devices. The user may also be referred to as a cardholder, account holder, or consumer in some embodiments.

A “user device” may be any suitable device that is operated by a user. The user device may include a processor and a computer-readable medium coupled to the processor, the computer-readable medium comprising code, executable by the processor. The user device may also each include an external communication interface for communicating with each other and other entities. Examples of user devices include cards that have data stored on them, mobile phones, laptop computers, transponders, wearable devices such as smart watches, automobiles with remote communication capabilities, access cards, smart media, etc. A payment device may be an example of a user device. A user device can be in the form of a communication device.

A “communication device” may be a device that includes one or more electronic components (e.g., an integrated chip) that can communicate with another device. For example, a communication device can be a computing device that includes at least one processor coupled to a memory that stores instructions or code for execution by the processor. A “portable communication device” can be a communication device that can be transported and operated by a user. A portable communication device may provide remote communication capabilities to a network. A portable communication device can be configured to transmit and receive data or communications to and from other devices. A portable communication device may be in the form of a mobile device such as a mobile phone (e.g., smart phone, cellular phone, etc.), tablets, portable media player, personal digital assistant devices (PDAs), wearable computing device (e.g., watch), health monitoring device, electronic reader device, etc., or in the form of a card (e.g., smart card) or a fob, etc. Examples of portable communication devices may also include portable computing devices (e.g., laptops, netbooks, ultrabooks, etc.). A portable communication device may also be in the form of a vehicle (e.g., an automobile), or be integrated as part of a vehicle (e.g., an infosystem of a vehicle).

A “resource” can be something of value to a user. A resource, for example, can include digital items and/or physical items. A resource can be an obtainable item. A resource can be owned by an entity. A resource can be a physical item such as goods. A resource can be a service that is provided by a merchant. A resource can be a digital item such as non-fungible tokens, secure data, etc. Another example of a resource is a secure location.

A “resource provider” may be an entity that can provide resources to a user. Examples of resource providers include entities that provide secure data (e.g., government entities), access to goods and services (e.g., merchants), access to locations (e.g., transit providers), etc. A “resource provider computer” may include any computer operated by a resource provider. In some embodiments, the resource provider computer may be an application server or a Web server operating a Website.

An “acquirer” may be a financial institution associated with a resource provider. Acquirers typically provide resource providers with a bank account, and in some cases, transaction accepting infrastructure. Generally, after a transaction has been authorized and as part of the settlement process, funds are transferred from the issuer to resource provider's account at the acquirer. The acquirer may also communicate a payment transaction status with the resource provider. The acquirer may operate an acquirer computer, which may generically be a transport computer.

An “authorizing entity” may be an entity that authorizes a request. Examples of an authorizing entity may be an issuer, a governmental agency, a document repository, an access administrator, etc. An authorizing entity may operate an authorizing entity computer.

An “issuer” may refer to a business entity (e.g., a bank) that issues and optionally maintains accounts for account holders. An issuer may also issue payment credentials associated with the accounts.

A “payment processing network” may be data processing subsystems, networks, and operations used to support and deliver authorization services, exception file services, and clearing and settlement services. An exemplary payment processing network may include VisaNet™. Payment processing networks such as VisaNet ™ are able to process credit card transactions, debit card transactions, and other types of commercial transactions. Authorization, settlement, and clearing may be done at the same time (substantially simultaneously, e.g., within a few minutes or hours) or may be done as part of a batch settlement process (e.g., at the end of the day or week). The payment processing network may include a server computer. The payment processing network may use any suitable wired or wireless network, including the internet.

A “server computer” may be a powerful computer or cluster of computers. For example, the server computer can be a large mainframe, a minicomputer cluster, or a group of servers functioning as a unit. In one example, the server computer may be a database server coupled to a Web server.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

“Access data” may include any suitable data that can be used to access a resource or create data that can access a resource. In some embodiments, access data may be a credential (e.g., a payment credential), a token, or some other type of information that can be used to access a resource. Such access data may be ticket information for an event, data to access a building, transit ticket information, etc. In yet other embodiments, access data may include data used to obtain access to sensitive data. Examples of access data may include codes or other data that are needed by a server computer to grant access to the sensitive data.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc. Other examples of credentials include PANs (primary account numbers), PII (personal identifiable information) such as name, address, and phone number, driver's license ID, social security number, and the like.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. A token may be bound to one or more devices (e.g., a user device). Examples of tokens include access tokens, payment tokens, personal identification tokens, etc.

A “key” may include a piece of information that is used in a cryptographic algorithm to transform data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include a cryptographic key that forms a public key of a public/private key pair. The public key may be designed to be shared (e.g., transmitted between entities) and may be configured such that any information encrypted with the public key may only be decrypted using a private key associated with the public key. In some embodiments, a public key may be an index in a distributed ledger.

A “private key” may include a cryptographic key that forms a private key of a public/private key pair. A private key may be used to decrypt data encrypted with a public key.

A “digital identity” (DI) or “electronic identifier” may include a secure set of information about an entity (e.g., a person, organization, or thing). A digital identity may comprise a plurality of user attributes, as well as an identifier of the digital identity. The user attributes may be pieces of information about the entity. For example, a digital identity for a user Joe Smith may include user attributes such as the user's date of birth, social security number, address, and driver's license number, as well as an identifier such as Joe_Smith_1234 which is used to identify Joe Smith's digital identity. The digital identity may be made available to another entity in a secure manner. Digital identities may rely on agreements among stakeholders and security measures such as cryptography.

An “user attribute” may be an attribute of an identity. User attributes may be pieces of information about an entity (e.g., a user). For example, a user attribute may be a user's date of birth, social security number, address, driver's license number, etc. One or more user attributes may be used to generate assertions about the entity. For example, the user attribute of date of birth may be used to generate an assertion that the user is at least 18 years of age.

An “assertion” may include a secure fact about an entity. For example, an assertion may specify something about an entity, such as whether the entity has the attributes required to rent a car. For example, an assertion about the entity in this context may be “this user is over 25 years old.” An assertion may be based on one or more user attributes, or pieces of information about the entity. An assertion may be secured cryptographically. An assertion may be digitally signed by the entity of interest and/or the trusted party providing the secure facts.

A “token service system” or alternatively a “token service computer” can include a system that services tokens. In some embodiments, a token service system can facilitate requesting, determining (e.g., generating) and/or issuing tokens, as well as maintaining an established mapping of tokens to access data in a repository (e.g., token vault). In some embodiments, the token service system may establish a token assurance level for a given token to indicate the confidence level of the token to access data binding. The token service system may include or be in communication with a token vault where the generated tokens are stored. The token service system may support token processing of transactions submitted using tokens by detokenizing the tokens to obtain the actual access data. In some embodiments, a token service system may include a tokenization computer alone, or in combination with other computers such as a transaction processing network computer. Various entities of a tokenization ecosystem may assume the roles of the token service system. For example, processing networks and issuers or their agents may become the token service system by implementing the token services.

A “token requestor” may refer to an entity that is seeking to implement tokenization according to embodiments of the present invention. The token requestor may initiate a request that a primary account number (PAN) be tokenized by submitting a token request message to the token service provider. According to various embodiments discussed herein, a token requestor may no longer need to store a PAN associated with a token once the requestor have received the token in response to a token request message. The requestor may be an application, a device, a process, or a system that is configured to perform actions associated with tokens. For example, a requestor can request registration with a network token system, request token generation, token activation, token de-activation, token exchange, other token lifecycle management related processes, and/or any other token related processes. A requestor may interface with a network token system through any suitable communication networks and/or protocols (e.g., using HTTPS, SOAP and/or an XML interface among others). Some non-limiting examples of token requestors may include, for example, card-on-file merchants, acquirers, acquirer processors, and payment gateways acting on behalf of merchants, payment enablers (e.g., original equipment manufacturers, mobile network operators, etc.), digital wallet providers, issuers, third party wallet providers, and/or payment processing networks. In some embodiments, a token requestor can request tokens for multiple domains and/or channels. A token requestor may be registered and identified uniquely by the token service provider within the tokenization ecosystem. During token requestor registration, the token service provider may formally process token requestor's application to participate in the token service system. The token service provider may collect information pertaining to the nature of the requestor and relevant use of tokens to validate and formally approve the token requestor and establish appropriate domain restriction controls. Successfully registered token requestors may be assigned a token requestor identifier that may also be entered and maintained within the token vault. Token requestors be revoked or assigned new token requestor identifiers. This information may be subject to reporting and audit by the token service provider.

A “token requestor identifier (ID)” may include any characters, numerals, or other identifiers associated with an entity associated with a network token system. In some embodiments, a unique token requestor ID may be assigned for each domain for a token request associated with the same token requestor. For example, a token requestor ID can identify a pairing of a token requestor (e.g., a mobile device, a mobile wallet provider, etc.) with a token domain (e.g., e-commerce, contactless, etc.). A token requestor ID may include any format or type of information. For example, in one embodiment, the token requestor ID may include an alphanumerical value such as a ten digit or an eleven digit letter and/or number (e.g., 4678012345). In some embodiments, a token requestor ID may include a code for a token service provider (e.g., first 3 digits) such as the network token system and the remaining digits may be assigned by the token service provider for each requesting entity (e.g., mobile wallet provider) and the token domain (e.g., contactless, e-commerce, etc.).

A “token request indicator” may refer to an indicator used to indicate that the message containing the indicator is related to a token request. The token request indicator may optionally be passed to the issuer as part of the Identification and Verification (ID&V) method to inform the issuer of the reason the account status check is being performed.

A “token domain” may indicate the factors that can be established at the time of token issuance to enable appropriate usage of the token for payment transactions. Examples of the token domain may include, but are not limited to, a POS entry mode, and merchant identifiers to uniquely identify where the token can be used. A set of parameters (i.e. token domain restriction controls) may be established as part of token issuance by the token service provider that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction.

“Token expiry date” may refer to the expiration date/time of the token that is generated by the token service provider and maintained in the token vault.

The token expiry date may be passed among the entities of the tokenization ecosystem during transaction processing to ensure interoperability and minimize the impact of tokenization implementation. The token expiration date may be a numeric value (e.g. a 4-digit numeric value) that is consistent with the industry standards.

### BRIEF DESCRIPTION OF THE DRAWINGS

FIG. 1 illustrates a block diagram of a system according to an embodiment.

FIG. 2 illustrates a block diagram of a system and an exemplary method for providing a second type of access data and attributes or assertions thereof to a token requestor.

FIG. 3 illustrates a block diagram of a system and an exemplary transaction authorization process.

FIG. 4 illustrates a block diagram of a system and a process that may refresh a time to live of an attribute refresh period and/or a consent period.

FIG. 5 illustrates a block diagram of a system and a process of revoking consent to access attributes or assertions thereof.

FIG. 6 illustrates a block diagram of a token service computer according to an embodiment.

FIG. 7 illustrates a block diagram of an identity hub according to an embodiment.

FIG. 8 illustrates a block diagram of an identity provider system according to an embodiment.

FIG. 9 illustrates a block diagram of a user device according to an embodiment.

FIG. 10 illustrates a block diagram of a token requestor according to an embodiment.

### DETAILED DESCRIPTION

In some embodiments, a method according to an embodiment comprises receiving, by a token service computer from a token requestor, a request message comprising a first type of access data (e.g., a credential such as an account number, an identifier for a token, etc.). The request message requests a second type of access data and a set of user attributes or assertions thereof for a user. The method further includes transmitting, to an identity hub, a request for the set of user attributes or assertions thereof of the user, the request including the first type of access data, and receiving, from the identity hub, a response message comprising the requested set of user attributes or assertions thereof of the user. The method further includes providing, to the token requestor, a modified response message including the requested set of user attributes (e.g., an age of the user) or assertions (e.g., an age range which includes an age of the user) thereof of the user and the second type of access data (e.g., a token).

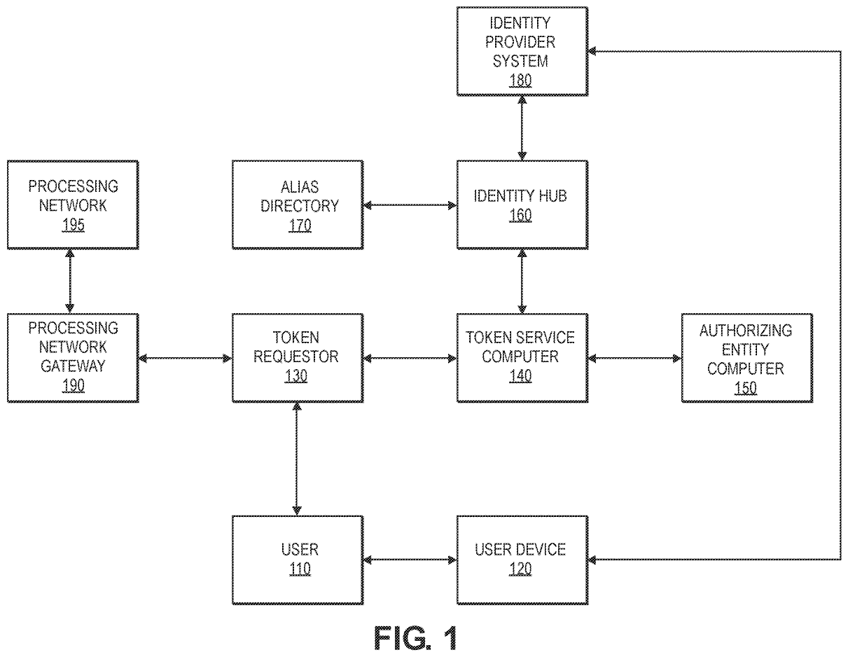

FIG. 1 illustrates a block diagram of a system 100 according to an embodiment. The system 100 may comprise the user 110 operating a user device 120. The user device 120 can be in communication with a token requestor 130 and an identity provider system 180. The token requestor 130 can be in communication with a token service computer 140, which may be in communication with an authorizing entity computer 150 and an identity hub 160. The identity hub 160 can be in communication with an alias directory 170 and an identity provider system 180. A processing network gateway 190 and a processing network 195 can be in communication with the token requestor 130. In some embodiments, the processing network gateway 190 can be operated by an acquirer.

Each of the devices and computers may be in operative communication with each other. For simplicity of illustration, a certain number of components are shown in system 100. It is understood, however, that embodiments of the invention may include more or less components than are illustrated in system 100. For example, although one identity provider system 180 is illustrated in FIG. 1, other systems can have many identity provider systems. For example, identity provider systems can include federal, state, and local governmental agencies such as the Department of Motor Vehicles in a state, the Social Security Administration, banks, private companies, identity services, etc.

Any of the devices in system 100 may be in communication via a suitable communications network. The communications network may include one and/or the combination of the following: a direct interconnection; the Internet; a Local Area Network (LAN); a Metropolitan Area Network (MAN); an Operating Missions as Nodes on the Internet (OMNI); a secured custom connection; cellular networks (e.g., using 3GPP standards such as 4G/5G). a Wide Area Network (WAN); a wireless network (e.g., employing protocols such as, but not limited to a Wireless Application Protocol (WAP), I-mode, and/or the like); and/or the like. Message between the entities, providers, networks, and devices illustrated in system 100 may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The user 110 may be associated with one or more personal accounts and/or user devices. The user 110 may interface with the token requestor 130 using the user device 120. The user 110 may provide input to the token requestor 130 to cause a transaction to be conducted and/or cause a token to be obtained. The user 110 may use user device 120 to interface with the identity provider system 180.

The user device 120 may be operated by the user 110. The user device 120 may be, for example, a mobile phone or a laptop computer. The user 110 may be associated with a digital identity, and may have a user identifier (e.g., Joe_Smith_1234 for a user “Joe Smith”). The user identifier may include data associated with, an account, a digital signature, and/or cryptographic key of the user 110. The user device 120 may store the user identifier. The user device 120 may also store a device identifier that can be used to identify the device (e.g., a MAC address, an IP address, a serial number (e.g., an electronic serial number (ESN)), international mobile equipment identity (IMEI) number) and is associated with the digital identity. The user 110 may also be associated with one or more tokens from the token service computer 140.

The token requestor 130 may be an entity that requests tokens or other second types of access data. In some embodiments, the token requestor 130 may be assigned a token requestor identifier. The token requestor identifier may include data associated with a digital signature and/or cryptographic key of the token requestor. The token requestor 130 may communicate with the user 110 through the user device 120. In some embodiments, the token requestor 130 can be a computer operated by a resource provider.

The identity hub 160 may be in communication with the identity provider system 180, the alias directory 170, and the token service computer 140. The identity hub 160 can serve as a hub between the token service computer 140, and various identity provider systems including identity provider system 180.

The alias directory 170 may be in communication with the identity hub 160. The alias directory 170 may store and/or have access to relationships between a digital identity identifier of a user, and one or more account identifier (e.g., PANs) of the user. For example, alias directory 170 can map a digital identity identifier such as a driver's license number, mobile number, e-mail address, personal identity number, etc. (including a link to the eID provider) to a credit card number and a debit card number of a user.

The identity provider system 180 may manage digital identities of various users. The identity provider system 180 may also include an application server, which manages a digital identity storage application (e.g., a digital identity wallet) on a user's mobile phone (or other user device). An example of a digital identity storage application is a digital identity wallet, such as the EU Digital Identity Wallet, which is being defined by the European Commission.

The identity provider system 180 may retrieve data from a primary source of information, and the data can be used as user attributes. The primary source of information may be referred to as a reference. References are generally trusted sources of information. A reference may be a verified document (e.g., a birth certificate, driver's license, password, credit card, etc.). Alternatively, or additionally, a reference may be an entity, such as a government agency, bank, individual (e.g., user 110), etc., that can provide trusted information. In some embodiments, the identity provider system 180 may establish a digital identity based on information gathered from one or more references. In some embodiments, the identity provider system 180 may be assigned an identifier. The identifier of the digital identity provider system may include data associated with a digital signature and/or cryptographic key of the identity provider system 180.

The processing network gateway 190 may route messages between the token requestor 130 and the processing network 195.

Processing network 195 may perform process interactions such as transactions. In some embodiments, the processing network 195 may be a payment processing network.

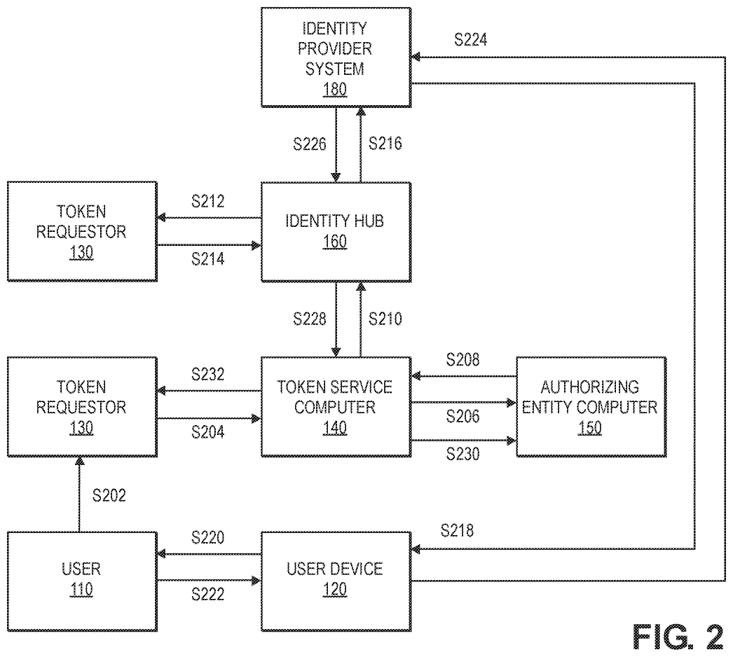

FIG. 2 illustrates a block diagram of a system 200 and a first exemplary process that may be conducted using the system 200. The system 200 includes a user 110, a token requestor 130, a token service computer 140, an authorizing entity computer 150, an identity hub 160, an alias directory 170, an identity provider system 180, and a user device 120. Descriptions of these components are provided above.

Methods according to embodiments can be described with reference to FIG. 2. The methods illustrate processes for performing token binding and delivering a second type of access data and user attributes or assertions thereof to a token requestor in a single data transmission.

At step S202, the user 110 may interact with the token requestor 130. For example, the interaction may be a transaction to obtain a resource from the token requestor 130. The token requestor 130 may be a merchant such as an online merchant. The user 110 may use the user device 120 or some other user device to transmit a first type of access data, and optionally a device identifier, to the token requestor 130. For example, the first type of access data may be an account identifier such as a primary account number associated with an account managed by an authorizing entity. In certain embodiments, described in more detail below, the token requestor 130 uses the device identifier to determine whether device-token binding has already occurred (e.g., whether a token is already associated with the device).

At step S204, the token requestor 130 may transmit a request message to the token service computer 140 to obtain a second type of access data such as a token and user attributes or assertions thereof. A user attribute may include information about the user 110. For example, the user attribute for a user may be that the user is 25 years old. An assertion may include a secure fact about a user, which obscures an attribute. In an example, an assertion may be that a user is over 21 years old. This can be characterized as a “zero knowledge proof” as the actual age is obscured, but the proof of the age is provided. This can obscure the actual age of the user, yet provide sufficient information for a resource provider to make a decision as to whether or not to provide a resource to the user. The token service computer 140 can then receive the request message from the token requestor 130.

At step S206, after receiving the request message, in some embodiments, the token service computer 140 may determine an authorizing entity (e.g., an issuer) associated with the first access data type. The token service computer 140 may transmit a device binding request to the authorizing entity computer 150 operated by the authorizing entity.

At step S208, the authorizing entity computer 150 may determine whether to authenticate the user 110 of the user device 120. The authorizing entity computer 150 may transmit the device binding response to the token service computer 140. The device binding response may include an indication (e.g., a value (e.g., “85”)) that can cause the token service computer 140 to authenticate the user 110 of the user device 120 before a device bound token is generated. The token service computer 140 may receive the device binding response from the authorizing entity computer 150.

At step S210, the token service computer 140 may select from a set of one or more authentication methods, an authentication method (e.g., a digital identity, password, one time password (OTP)) to use to authenticate the user 110 of the user device 120. One or more authentication methods in the set of authentication methods may be associated with a priority higher than other authentication methods. The token service computer 140 may select the authentication method based on the priority associated with the authentication methods (e.g., the one with the highest priority). The token service computer 140 may also select an authentication method that uses a digital identity for authentication. In embodiments where the token service computer 140 selects an authentication method that uses a digital identity for authentication, the token service computer 140 may transmit a request to the identity hub 160. The request may be an authentication request and/or may request the set of user attributes or assertions thereof of the user to the identity hub 160. The request may include the first type of access data, which may include a credential such as a primary account number (PAN). The identity hub 160 may receive the request from the token service computer 140.

At step S212, the identity hub 160 may use information included in the request (e.g., the PAN) to look up, in the alias directory 170, a digital identity associated with the user 110.

At step S214, after receiving the request from the identity hub 160 and performing the lookup, the alias directory 170 may transmit the digital identity to the identity hub 160. The identity hub 160 may receive the digital identity from the alias directory 170.

At step S216, after the identity hub 160 obtains the digital identity associated with the user from the alias directory 170, the identity hub 160 may transmit a request for the set of user attributes or assertions thereof of the user 110 to the identity provider system 180. The request may obtain a digital identity of the user 110. The digital identity can include information such as a user identifier, a user identity provider system identifier and an address (e.g., a network address) of the identity provider system 180 which holds identity information of the user 110.

At step S218, the identity provider system 180 may use the request to determine which user is associated with the request. In certain embodiments, the user 110 is associated with the digital identity included in the request.

The identity provider system 180 (e.g., an identity provider computer) may transmit a challenge message to the user device 120 of the user 110 associated with the digital identity. The challenge message may challenge the user 110 of the user device 120 to authenticate using an authentication credential such as a password, a biometric, etc. The challenge message may further include information about the token requestor 130 so that the user 110 of the user device 120 can determine whether to share information (e.g., a particular user attribute or assertion) with the token requestor 130). The user device 120 of the user 110 may receive the challenge message in a notification from the identity provider system 180.

At step S220, the notification requests the user 110 to consent to sharing a set of user attributes or assertions thereof with the token requestor 130. The notification may also allow the user 110 to specify how long the user attributes or assertions thereof can be shared with the token requestor 130.

At step S222, the user 110 may respond to the notification with the challenge response and can consent to the sharing of the attributes or the assertions thereof with the token requestor.

At step S224, the user device 120 may transmit a challenge response to the identity provider system 180. The challenge response may include the entered authentication credential as well as the consent to share the set of user attributes or assertions thereof, and any limitations on the sharing, with the token requestor 130.

At step S226, the identity provider system may retrieve the set of user attributes or assertions thereof from a database. It may then transmit a message including the set of user attributes or assertions thereof and the limitations on the sharing to the identity hub 160. The limitations on the sharing of the user attributes or the assertions thereof can be examples of refresh data.

The refresh data may indicate the period of time (e.g., a time to live) until the consent expires and/or until user attributes or assertions thereof are to be refreshed. The time to live included in the refresh data may be based on input provided by the user 110 (e.g., an attribute refresh period and/or a consent period provided by the user 110). In certain embodiments, the time to live is generated by the identity provider system 180. For example, the identity provider system 180 may assign a time to live based on the set of user attributes or assertions thereof of the user 110, the token requestor 130.

At step S228, the identity hub 160 may transmit a response message including the requested set of user attributes and/or assertions thereof to the token service computer 140. The response message may also include the refresh data and/or the digital identity of the user 110.

At step S230, the token service computer 140 may generate or obtain a second type of access data such as a token based on the credential received in step S202. The token service computer 140 may store the token in memory and associate the token with the credential. The token service computer 140 may also transmit an authentication details message to the authorizing entity computer 150.

The authentication details message may include an indication of what type of authentication was used by the token service computer 140, when authentication took place, or other authentication details.

At step S232, the token service computer 140 may transmit a modified response message to the token requestor 130. The modified response message may include the token, which is an example of a second type of access data, and the requested set of user attributes or assertions thereof of the user 110. In the above described example, the first type of access data received by the token service computer 140 in step S204 includes a credential or a token identifier. The second type of access data included in the modified response message may include a token such as a payment token. In some embodiments, the modified response message may also include a token cryptogram.

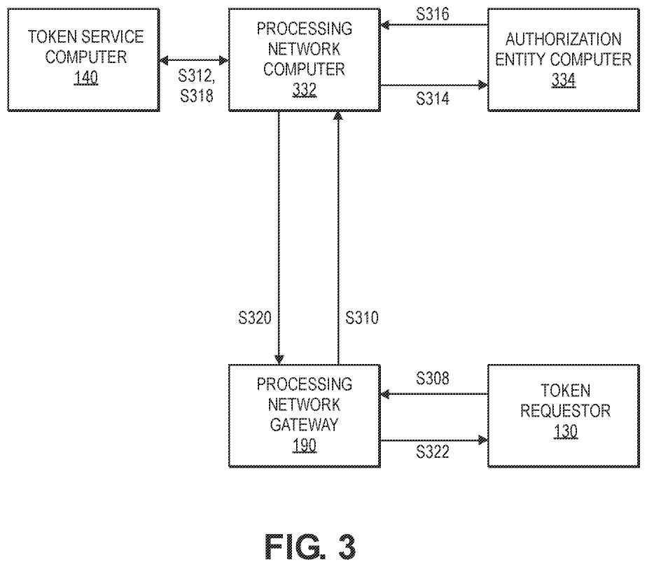

FIG. 3 illustrates a block diagram of a system 300 and an exemplary payment authorization process using a token that has been provided to a token requestor 130, as in FIG. 2 above. The token requestor 130 can evaluate the requested set of user attributes or assertions thereof of the user 110 to determine if the transaction is to proceed. For example, the token requestor 130 can be a computer operated by a winery that mail orders wine. The set of user attributes in this example could include an age such as “35 years old” and an assertion thereof may be “the user is over 21 years old.” The requested set of user attributes or assertions thereof of the user 110 can be used by the token requestor to determine if wine can be delivered to the user 110. Other examples of assertions can include “has a valid driver's license.”

At step S308, the token requestor 130 may generate and transmit an authorization request message comprising the token, the token cryptogram, and a transaction amount to the processing network gateway 190.

At step S310, the processing network gateway 190 may transmit the authorization request message comprising the token, the token cryptogram, and a transaction amount to the processing network computer 332.

At step S312, the processing network computer 332 exchanges the token for the credential (e.g., a PAN). It also sends the cryptogram to the token service computer 140 which validates the cryptogram before the token service computer 140 provides the credential to the processing network computer 332.

At step S314, after receiving the authorization request message, the processing network computer 332 then transmits the authorization request message comprising the credential and the value to the authorizing entity computer 334.

At step S316, the authorizing entity computer 334 may determine whether to authorize the transaction. The authorizing entity computer 334 may send an authorization response message to the processing network computer 332 indicating whether the transaction is approved or declined.

At step S318, the processing network computer 332 exchanges the credential for the token.

At step S320, the processing network computer 332, transmits an authorization response message including the token to the processing network gateway 190.

At step S322, the processing network gateway 190 can transmit the authorization response message to the token requestor 130. Assuming that the transaction is approved, the token requestor 130 can then provide the requested resource to the user.

At the end of the day or another period of time, a clearing and settlement process can occur between the processing network gateway 190, the processing network computer 332, and the authorizing entity computer 334.

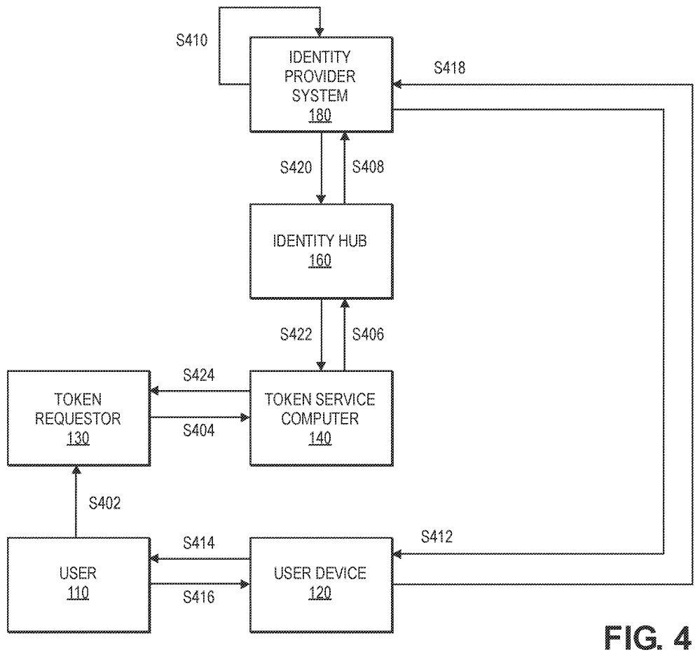

FIG. 4 illustrates a block diagram of a system and a process that may refresh a time to live of an attribute refresh period and/or a consent period.

At step S402 the user 110 may interact with the token requestor 130 to request a device-bound token and user attributes or assertions thereof. However, the token requestor 130 may determine that the time to live associated with the attributes or assertions thereof of the user 110 has been exceeded, and that the refresh data needs to be updated.

At step S404, a request message may be transmitted from the token requestor 130 to the token service computer 140.

At step S406, the token service computer 140 may determine one or more tokens in memory that are associated with the user 110 or their user device 120. The token service computer 140 may determine that refresh data associated with the one or more tokens associated with the user 110 has expired (e.g., the time to live of an attribute and/or consent has passed). The token service computer 140 may generate a request for refreshed data (e.g., an updated attribute refresh period, an updated consent period). The request for updated refresh data may include the one or more tokens associated with the user 110, the refresh data, a device identifier, a user identifier, and/or a digital identity of the user 110. The identity hub 160 may receive the request for updated refresh data from the token service computer 140.

At step S408, the identity hub 160 may transmit the request for updated refresh data to the identity provider system 180.

At step S410, the identity provider system 180 may determine whether a user attribute refresh period time to live has ended and/or whether a consent period time to live has ended before transmitting updated refresh data to the identity hub 160. In certain embodiments, one or both of the user attribute refresh period and consent period has ended and a refresh for one or more user attributes and/or user consent is needed before transmitting updated refresh data to the identity hub 160.

In certain embodiments, the identity provider system 180 determines user consent is unnecessary because the consent period time to live is still valid (e.g., has not ended). In such embodiments, the identity provider system 180 can generate the updated refresh data including a refreshed user attribute without requesting user consent.

In certain embodiments, the identity provider system 180 determines user consent is needed. In such embodiments, the identity provider system can generate and transmit a request for user consent in step S412.

Steps S412, S414, S416, and S418 may be performed similar to steps S218, S220, S222, and S224 described above with respect to system 200, respectively.

At step S420, after the user 110 has consented, the identity provider system 180 can generate updated refresh data. The updated refresh data may be transmitted to the identity hub 160. The updated refresh data may include a digital identity, a set of one or more user attributes or assertions thereof of the user, an updated attribute refresh period, and/or an updated consent period.

At step S422, the identity hub 160 may transmit a subsequent response message to the token service computer 140. The subsequent response message may include the updated refresh data. The updated refresh data may include the requested set of one or more user attributes and/or the one or more assertions thereof of the user. The updated refresh data may include a token (e.g., a refresh token).

In step S424, the token and the requested attributes or assertions thereof are sent to the token requestor 130. The token requestor 130 can now perform a transaction such as described above with respect to FIG. 3.

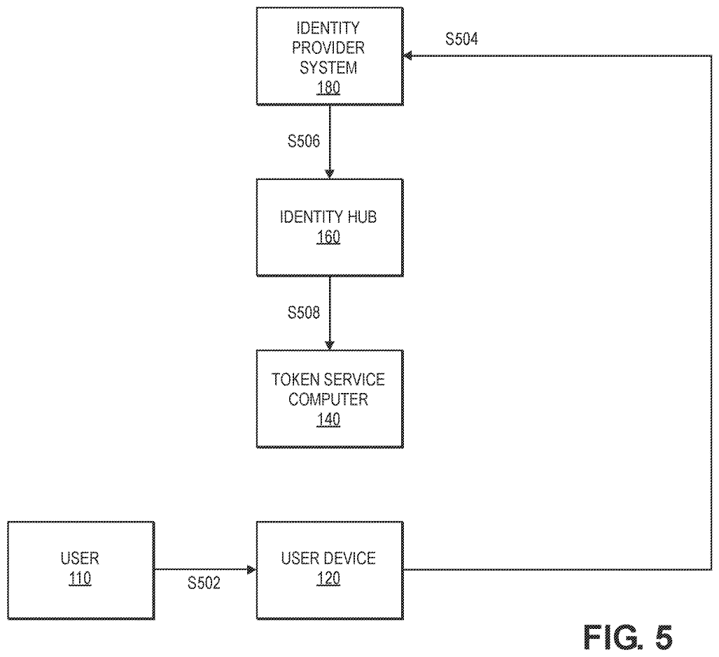

FIG. 5 illustrates a block diagram of a system and a process of revoking consent to access attributes or assertions thereof.

At step S502, the user 110 may initiate a process to revoke a token requestor's access to a token stored by the token service computer 140 by interacting with a user interface of the user device 120. The user device 120 may receive the input from the user 110.

At step S504, the user device 120 may transmit a consent revocation message to the identity provider system 180. The consent revocation message may indicate that the consent to share the set or a portion of the set of user attributes or assertions thereof of the user 110 with the token requestor 130 is being revoked. The consent revocation message may indicate one or more other systems (e.g., the token service computer 140 and/or the identity provider system 180) that should no longer be capable of accessing the set or a portion of the set of user attributes or assertions thereof of the user 110. The consent revocation message may include an identifier of the user 110 (e.g., a digital identity) so that the identity provider system 180 can determine which attributes or assertions thereof should not be shared with an indicated token requestor 130. The identity provider system 180 may receive the consent revocation message from the user device 120.

At step S506, the identity provider system 180 may optionally transmit the consent revocation message to the identity hub 160. The consent revocation message may include at least a portion of the information included in the consent revocation message received by the identity provider system 180.

At step S508, the identity hub 160 may optionally transmit the consent revocation message to the token service computer 140.

After receiving the consent revocation message, the token service computer 140 may record that consent to share the attributes or assertions has been revoked.

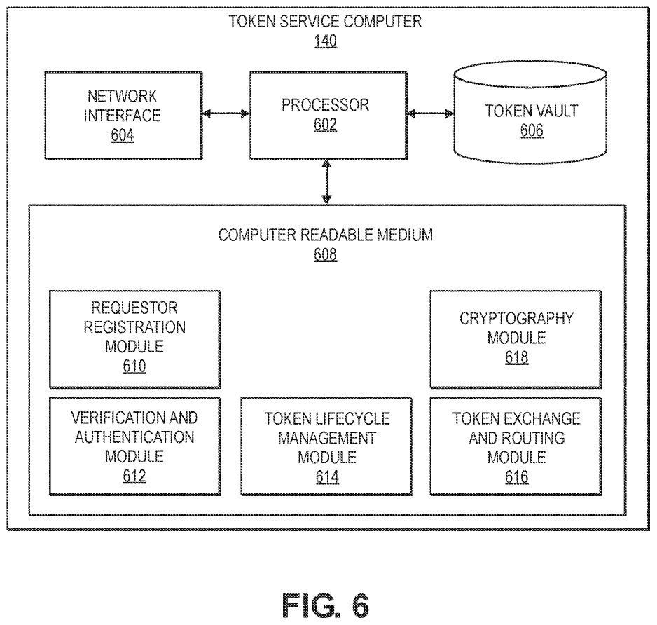

FIG. 6 illustrates a block diagram of a token service computer 140 according to an embodiment. The token service computer 140 may include a processor 602, and a network interface 604, a token vault 606, and/or a computer readable medium 608 coupled to the processor.

The token vault 606 can store tokens and their mappings to credentials and token cryptograms. Attributes and/or assertions therefore can also be stored in the token service computer in association with tokens in the token vault 606, or in a separate data storage in the token service computer 140.

The computer readable medium 608 may comprise a number of software modules including a requestor registration module 610, a verification and authentication module 612, a token lifecycle management module 614, a cryptography module 618, and/or a token exchange and routing module 616.

The requestor registration module 610 and the processor 602 may register a token requestor.

The verification and authentication module 612 may comprise code that causes the processor 602 to validate a cryptogram or token, or a user.

The token lifecycle management module 614 may comprise code, executable by processor 602, to generate and/or delete tokens from the token vault 606. The token lifecycle management module 614 may comprise code that may cause the processor 602 to disassociate a token with a token requestor.

The cryptography module 618 may comprise code, executable by the processor 602, to perform secure operations such as cryptographic operations.

The token exchange and routing module 616 may comprise code, executable by the processor 602, to receive and transmit tokens.

The computer readable medium 608 may also comprise code executable by the processor 602 to perform operations including: receiving, from a token requestor, a request message comprising a first type of access data, the request message requesting a second type of access data and a set of user attributes or assertions thereof for a user; transmitting, to an identity hub, a request for the set of user attributes or assertions thereof of the user, the request comprising the first type of access data; receiving, from the identity hub, a response message comprising the requested set of user attributes or assertions thereof of the user; and providing, to the token requestor, a modified response message requested set of user attributes or assertions thereof of the user and the second type of access data.

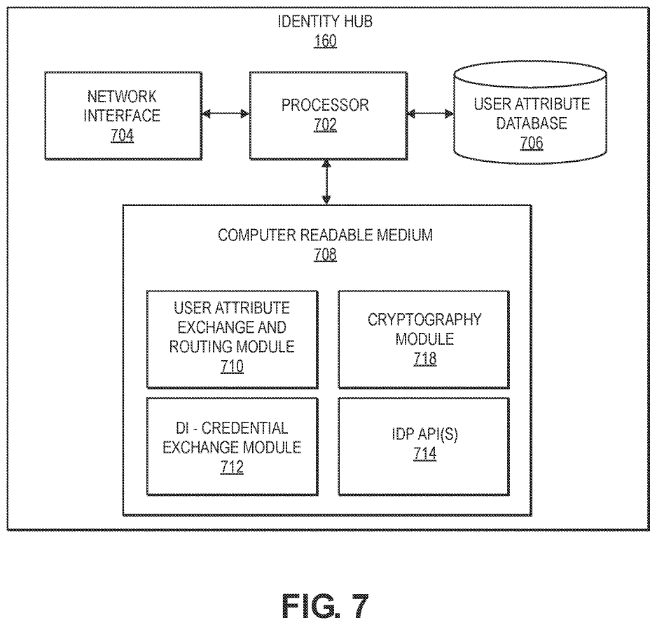

FIG. 7 illustrates a block diagram of an identity hub 160 according to an embodiment. The identity hub 160 may include a processor 702, which is coupled to a network interface 704, a user attribute database 706, and a computer readable medium 708.

The user attribute database 706 may store a set of user attributes or assertions thereof of a user.

The computer readable medium 708 may comprise a number of software modules including a user attribute exchange and routing module 710, an DI (digital identity)—credential exchange module 712, Identity Provider (IDP) Application Programing Interfaces (APIs) 714, and a cryptography module 718.

The user attribute exchange and routing module 710 may comprise code, executable by the processor 702, to transmit and receive user attributes and/or assertions thereof.

The digital identity—credential exchange module 712 may comprise code, executable by the processor 702, to transmit a credential (e.g., a PAN) to an alias directory to subsequently cause the identity hub 160 to receive a digital identity from the alias directory.

The Identity Provider (IDP) Application Programing Interfaces (APIs) 714 may comprise code, executable by the processor 702, to interface with one or more identity provider systems.

The cryptography module 718 may comprise code, executable by the processor 702, to perform secure operations such as cryptographic operations. The cryptography module 718 can also have a secure memory for storing cryptographic keys. The cryptography module 718 may be used to perform secure communication with a user device, an identity provider system, a token service computer, an alias directory, etc.

The computer readable medium 708 may also comprise code executable by the processor 702 to perform operations including: receiving, by an identity hub from a token service computer, a request for a set of user attributes or assertions thereof of a user, the request comprising a first type of access data; after receiving the request for the set of user attributes or assertions thereof of the user, obtaining, by the identity hub from an alias directory, an electronic identifier using the first type of access data; obtaining the requested set of user attributes or assertions thereof of the user from an identity provider computer using the electronic identifier; and transmitting, by the identity hub to the token service computer, a response message comprising the requested set of user attributes or assertions thereof of the user.

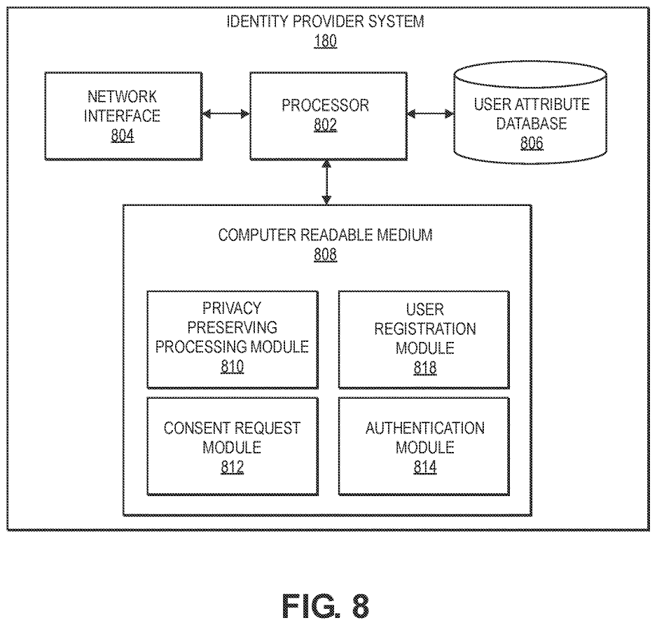

FIG. 8 illustrates a block diagram of an identity provider system 180 according to an embodiment. The identity provider system 180 may include a processor 802 coupled to a network interface 804, a user attribute database 806, and a computer readable medium 808.

The user attribute database 806 may store a set of user attributes or assertions thereof of a user.

The computer readable medium 808 may comprise a number of software modules including a privacy preserving processing module 810, a consent request module 812, an authentication module 814, and a user registration module 818.

The privacy preserving processing module 810 may comprise code executable by the processor 802 to generate assertions associated to a digital identity based on a set of user attributes.

The consent request module 812 may comprise code executable by the processor 802 to determine whether consent from a user associated with a digital identity should be obtained.

The authentication module 814 may comprise code executable by the processor 802 to perform authentication processes.

The user registration module 818 may comprise code executable by the processor 802 to register a user and/or a user device with the identity provider system 180.

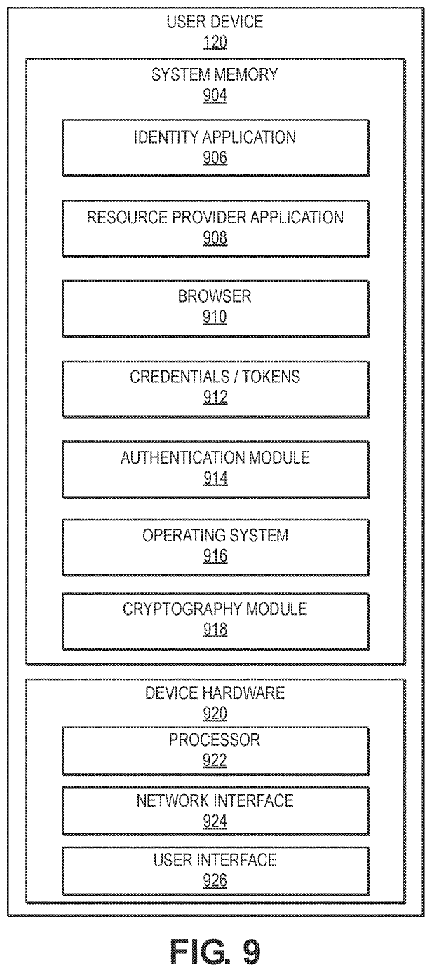

FIG. 9 illustrates a block diagram of a user device 120 according to an embodiment. The user device 120 may include device hardware 920 coupled to a system memory 904. The user device 120 can be a communication device such as a mobile phone.

Device hardware 920 may include a processor 922, a network interface 924, and/or a user interface 926. The network interface 924 may include a short range antenna, a long range antenna, etc. The user interface 926 may include input elements and output elements. Examples of input elements may include microphones, keypads, touchscreens, sensors, etc. Examples of output elements may include speakers, display screens, and tactile devices. The processor 922 can be implemented as one or more integrated circuits (e.g., one or more single-core or multicore microprocessors and/or microcontrollers), and is used to control the operation of user device 120. The processor 922 can execute a variety of programs in response to program code or computer-readable code stored in the system memory 904, and can maintain multiple concurrently executing programs or processes.

The network interface 924 may include one or more RF transceivers and/or connectors that can be used by user device 120 to communicate with other devices and/or to connect with external networks. The user interface 926 can include any combination of input and output elements to allow a user to interact with and invoke the functionalities of user device 120. The short range antenna may be configured to communicate with external entities through a short range communication medium (e.g., using Bluetooth, Wi-Fi, infrared, NFC, etc.). The long range antenna may be configured to communicate with a remote base station and a remote cellular or data network, over the air.

The system memory 904 can be implemented using any combination of any number of non-volatile memories (e.g., flash memory) and volatile memories (e.g., DRAM, SRAM), or any other non-transitory storage medium, or a combination thereof media. The system memory 904 may store computer code, executable by the processor 922, for performing any of the functions described herein.

The system memory 904 may also store an identity application 906, a resource provider application 908, a browser 910, one or more credentials and/or tokens 912, an authentication module 914, an operating system 916, and/or a cryptography module 918.

The identity application 906 may include instructions or code to communicate with an identity provider system. The identity application 906 may be associated with the identity provider system. In some embodiments, the identity application 906 may be a digital wallet application.

The resource provider application 908 may include instructions or code for communicating with a resource provider, which may be a token requestor.

The browser 910 may include instructions or code to communicate with a server (e.g., remote server) via the Internet.

The one or more credentials and/or tokens 912 include information identifying the user device 120 and/or the user of the user device 120. Examples of credentials may include a public key associated with the user device 120 and/or the user of the user device 120, a digital signature, payment credentials, biometric data (e.g., biometric samples or templates), etc.

The authentication module 914 may comprise code, executable by the processor 206, to authenticate a user. This can be performed using user secrets (e.g., passwords) or user biometrics.

The cryptography module 918 may comprise code, executable by the processor 206, to perform secure operations such as cryptographic operations. The cryptography module 918 can also have a secure memory for storing cryptographic keys.

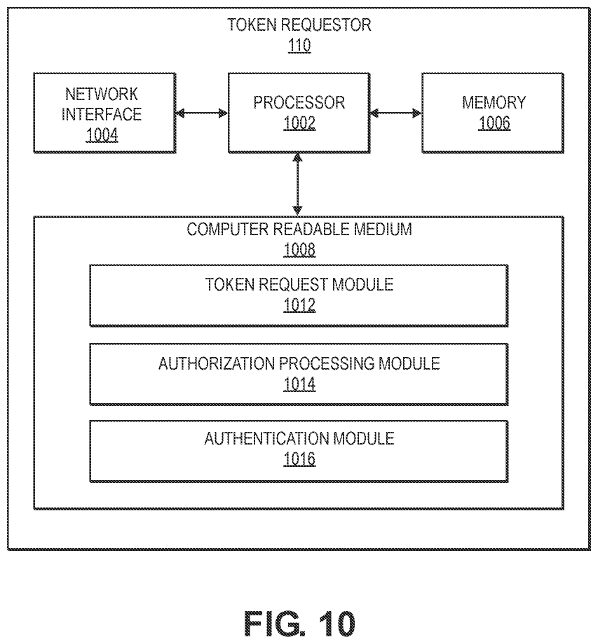

FIG. 10 illustrates a block diagram of a token requestor according to an embodiment. The token requestor 130 may include a processor 1002, coupled to a network interface 1004, a memory 1006, and a computer readable medium 1008.

The memory 1006 can be implemented using any combination of any number of non-volatile memories (e.g., flash memory) and volatile memories (e.g., DRAM, SRAM), or any other non-transitory storage medium, or a combination thereof media. The memory 1006 may store tokens, credentials, access data, a token device binding status, encryption keys, user identifiers, user account information, and/or other information as described herein.

The computer readable medium 1008 may comprise a number of software modules including a token request module 1012, an authorization processing module 1014, and/or an authentication module 1016.

Embodiments have a number of advantages. First, embodiments of the invention can use tokens instead of real credentials, and can also use assertions instead of user attributes to perform interactions. Tokens and/or assertions can keep sensitive user data private while still allowing users to conduct interactions to obtain resources. In addition, embodiments of the invention can provide attributes or assertions thereof to resource providers along with tokens in a single response message from a hub. There is no need for the user to manually provide multiple types of access credentials to a resource provider when conducting an interaction with the resource provider. This can save on the number of messages transmitted compared to conventional processes, and embodiments of the invention can, at the same time, protect all of the sensitive data being used to facilitate the interaction.

Embodiments of the invention have other advantages. In embodiments of the invention, user attributes are shared only with the intended party (token requester)—it is not possible for another party to use the token provided to someone else (domain control). Also, in embodiments of the invention, the user attributes can be revoked (“right to be forgotten”) by the user. Further, embodiments of the invention are convenient as an existing infrastructure for payment tokens can be extended to hold identity information.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a token service computer from a token requestor, a request message comprising a first type of access data, the request message requesting a second type of access data and a set of user attributes or assertions thereof for a user;
transmitting, by the token service computer to an identity hub, a request for the set of user attributes or assertions thereof of the user, the request comprising the first type of access data;
receiving, by the token service computer from the identity hub, a response message comprising the requested set of user attributes or assertions thereof of the user; and
providing, by the token service computer to the token requestor, a modified response message comprising the requested set of user attributes or assertions thereof of the user and the second type of access data.

2. The method of claim 1, wherein the response message further comprises refresh data associated with a time to live with respect to the set of user attributes or assertions.

3. The method of claim 1, wherein the identity hub, after receiving the request message for the set of user attributes or assertions thereof of the user, obtains an electronic identifier associated with the user from an alias directory using the first type of access data, and obtains the requested set of user attributes or assertions thereof of the user from an identity provider computer.

4. The method of claim 3, wherein the identity provider computer obtains consent from the user via a user device of the user to share the set of user attributes or assertions thereof of the user with the token requestor.

5. The method of claim 1, wherein the token requestor is a resource provider computer.

6. The method of claim 1, wherein the first type of access data comprises a credential and the second type of access data comprises a token or a token identifier.

7. The method of claim 1, wherein the response message further comprises refresh data associated with a time to live with respect to the set of user attributes or assertions, and the time to live is based on an attribute refresh or a consent period provided by the user.

8. The method of claim 1, wherein the response message comprising the requested set of user attributes or assertions thereof of the user comprises the assertions of the user.

9. The method of claim 1, further comprising:
receiving, by the token service computer from the identity hub, a message indicating a consent has been removed for access to the requested set of user attributes or assertions thereof of the user.

10. The method of claim 1, wherein the first type of access data is a driver's license identifier or government issued user identifier, and the second type of access data is a token of the driver's license identifier or the government issued identifier.

11. The method of claim 1, further comprising:
receiving, by the token service computer, a detokenization request message from a processing network computer, after the token requestor provides an authorization request message comprising the second type of access data;
determining, by the token service computer, the first type of access data using the second type of access data; and
providing, by the token service computer, a detokenization response message comprising the first type of access data to the processing network computer.

12. The method of claim 11, wherein the first type of access data comprises a credential and the second type of access data comprises a token.

13. The method of claim 12, wherein the processing network computer transmits the authorization request message comprising the credential to an authorizing entity computer for authorization.

14. A token service computer comprising:
a processor; and
a computer readable medium comprising code executable by the processor for performing operations comprising:
receiving, from a token requestor, a request message comprising a first type of access data, the request message requesting a second type of access data and a set of user attributes or assertions thereof for a user;
transmitting, to an identity hub, a request for the set of user attributes or assertions thereof of the user, the request comprising the first type of access data;
receiving, from the identity hub, a response message comprising the requested set of user attributes or assertions thereof of the user; and
providing, to the token requestor, a modified response message requested set of user attributes or assertions thereof of the user and the second type of access data.

15. A method comprising:
receiving, by an identity hub from a token service computer, a request for a set of user attributes or assertions thereof of a user, the request comprising a first type of access data;
after receiving the request for the set of user attributes or assertions thereof of the user, obtaining, by the identity hub from an alias directory, an electronic identifier using the first type of access data;
obtaining the requested set of user attributes or assertions thereof of the user from an identity provider computer using the electronic identifier; and
transmitting, by the identity hub to the token service computer, a response message comprising the requested set of user attributes or assertions thereof of the user.

16. The method of claim 15, wherein the token service computer provides to a token requestor, a modified response message comprising the requested set of user attributes or assertions thereof of the user and a second type of access data.

17. The method of claim 16, wherein the first type of access data comprises a credential and the second type of access data comprises a token.

18. The method of claim 15, wherein the response message further comprises refresh data associated with a time to live with respect to the set of user attributes or assertions, and the time to live is based on an attribute refresh or a consent period provided by the user.

19. The method of claim 18, further comprising:
receiving, by the identity provider computer, a subsequent request for the set of user attributes or assertions thereof of the user;
determining, that the subsequent request is not past the time to live; and
transmitting, by the identity provider computer, to the token service computer, a subsequent response message comprising the set of user attributes or assertions thereof of the user without contacting a user device.

20. The method of claim 18, further comprising:
receiving, by the identity provider computer, a subsequent request for the set of user attributes or assertions thereof of the user;
determining, that the subsequent request is past the time to live;
obtaining the requested set of user attributes or assertions thereof of the user from a user device using the electronic identifier; and
transmitting, by the identity hub to the token service computer, a subsequent response message comprising the requested set of user attributes or assertions thereof of the user.
